(19) United States
(12) Patent Application Publication
(10) Pub. No.: US 2024/0363973 A1
(43) Pub. Date: Oct. 31, 2024

(54) BATTERY CELL AND METHOD OF MANUFACTURING SUCH A BATTERY CELL

(71) Applicant: Volkswagen Aktiengesellschaft, Wolfsburg (DE)

(72) Inventor: Mesut YURTSEVEN, Salzgitter (DE)

(73) Assignee: Volkswagen Aktiengesellschaft, Wolfsburg (DE)

(21) Appl. No.: 18/647,823

(22) Filed: Apr. 26, 2024

(30) Foreign Application Priority Data
Apr. 26, 2023 (DE) 10 2023 203 846.3

(51) Int. Cl. H01M 50/533; H01M 50/46

(52) U.S. Cl. CPC H01M 50/533; H01M 50/46

(57) ABSTRACT

A battery cell with a cell casing in which a cell stack is arranged. An intermediate battery cell product is formed during a process for manufacturing the battery cell, in which the cell stack is arranged inside the casing and an arrester bundle formed from arrester lugs of the cell stack is extended with a contact element that is electrically contactable with a cell terminal of the battery cell. A composite formed of arrester lug bundle and contact element protrudes from an open cell casing opening at right angles to a cell stack stacking direction. In the assembled state, the composite formed of arrester lug bundle and contact element is positioned in a bending process in a mounting gap between the cell stack and a wall element. The contact element, which is in particular rigidly formed, remains undeformed, i.e., not bent, during the bending process.

This nonprovisional application claims priority under 35 U.S.C. § 119 (a) to German Patent Application No. 10 2023 203 846.3, which was filed in Germany on Apr. 26, 2023, and which is herein incorporated by reference.

### BACKGROUND OF THE INVENTION

### Field of the Invention

The invention relates to a battery cell and a method of manufacturing such a battery cell.

### Description of the Background Art

A prismatic battery cell has a cell stack inside the cell casing, i.e., an electrode/separator stack in which anodes and cathodes are alternately arranged on top of each other in a stacking direction with an intermediate layer of separators. The anodes are extended laterally from the cell stack with anode-side arrester lugs, while the cathodes are extended laterally from the cell stack with cathode-side arrester lugs.

In a generic battery cell, the lateral outer ends of the anode-side arrester lugs are compacted into an anode-side arrester lug bundle, while the lateral outer ends of the cathode-side arrester lugs are compacted into a cathode-side arrester lug bundle. The anodes and cathodes each have a flexible substrate film coated with active material. The arrester lug is a material-uniform as well as one-piece component of the substrate film.

The arrester lugs protruding laterally from the cell stack have only a low inherent stiffness. As a result, the arrester lugs are difficult to handle in the manufacturing process beyond a certain overall length. The arrester lugs must therefore be designed with a sufficiently short overall length. Due to the short overall length, the arrester lug bundle is not in direct electrical contact with the cell terminal, but the arrester lug bundle is extended with a rigid contact element or a tab that can be electrically contacted with a corresponding cell terminal of the battery cell.

When manufacturing the battery cell, an intermediate battery cell product is formed in which the composite of arrester lug bundle and contact element protrudes outwards at right angles to a cell stack direction with a protrusion from an open cell casing opening. When assembling the battery cell, a bending process is now carried out in which the composite of arrester lug bundle and contact element is positioned in a mounting gap inside the casing between the cell stack and a wall element, in particular the cell case back. According to the state of the art, a Z-fold is performed in the bending process, in which contact element sections are folded around a first bending point and the softer arrester lugs are also bent around a second bending point. Due to their comparatively high inherent stiffness, the contact element sections may not bend sufficiently during assembly or they may spring back elastically. In this case, a contact element section close to the cell stack can damage or deform the flexible cell stack side.

From WO 2020/156951 A1, which corresponds to US 2022/0089038, a battery cell is known in which a plurality of electrodes of a first polarity and a plurality of electrodes of a second polarity opposite to the first polarity are arranged in an electrode stack. The electrodes of the first polarity each have a first arrester lug that protrudes from the electrode stack on a first side of the electrode stack. In contrast, the electrodes of the second polarity each have a second arrester lug that protrudes from the electrode stack on a second side of the electrode stack opposite the first.

### SUMMARY OF THE INVENTION

The object of the invention is to provide a battery cell as well as a method for manufacturing such a battery cell, with the aid of which the battery cell can be flawlessly assembled in comparison to the state of the art.

In an example, the invention is based on a battery cell with a cell casing in which a cell stack is arranged. During the process of manufacturing the battery cell, an intermediate battery cell product is formed in which the cell stack is arranged inside the casing and an arrester bundle formed from cell stack arrester lugs is extended with a contact element. The contact element can be electrically contacted with a cell terminal of the battery cell. In the intermediate battery cell product, the composite of arrester lug bundle and contact element protrudes at right angles to a cell stack stacking direction with a protrusion from an open cell casing opening. In the further manufacturing process, the battery cell is assembled, in which the composite of the arrester lug bundle and the contact element is positioned in a bending process in a mounting gap between the cell stack and a wall element that closes the cell casing opening. During the bending process, the contact element, which is in particular rigidly formed, remains undeformed, i.e., not bent. Rather, only the particularly flexible arrester lugs are deformed during the bending process. Since, according to the invention, only the arrester lugs are bent, but not the more rigid contact elements, damage or deformation of the flexible cell stack side can be prevented. In contrast, such deformation of the cell stack side would occur if the more rigid contact element were also to be deformed by bending during the bending process. In this case, if the contact element were to be insufficiently bent, an interference contour would be formed, by means of which the flexible cell stack side could be deformed.

In the intermediate battery cell product, the contact element can be connected to a cell terminal that is part of the wall element. The connection can be made, for example, by means of a material fit, for example by ultrasonic welding or by bonding.

The contact element can be designed in two parts, formed of a base sheet part and a separate additional sheet part. The base sheet part can be connected directly to the cell terminal. In addition, the base sheet part together with the additional sheet part can form a weld point, in particular an ultrasonic weld, in which the arrester lug bundle is welded between the additional sheet part and the base sheet part. By using the additional sheet part, the ultrasonic weld tool is not brought into direct contact with the arrester lug bundle. Rather, the pressure is applied with the additional sheet part in between, so that damage to the arrester lug bundle can be prevented.

The arrester lugs protrude laterally from the cell stack. In addition, in the intermediate battery cell product, the laterally outer arrester lug ends can be compacted to form the arrester lug bundles in a pre-fixing step, in which the arrester lug ends are stacked on top of each other in a stacking direction without gaps or air pockets.

In an area between the cell stack and the arrester lug bundle, the arrester lugs can have a bending axis or bending point, around which the arrester lug bundle can be folded into the mounting gap during the bending process. The bending axis or bending point is defined in the arrester lugs, especially at the transition to the arrester lug bundle.

According to the invention, a U-fold is carried out during the bending process, in which the contact element is folded around the bending axis/bending point, and this is done by bending the flexible arrester lugs around the bending axis, whereby the composite of contact element and arrester lug bundle can be positioned in the mounting gap inside the casing.

In order to enable simple assembly without interference contours, it is preferable if the contact element connected to the cell terminal in the intermediate battery cell product has a cross-section dimensioned smaller in size than the wall element. In this case, the contact element may be formed by an offset within a wall element circumferential edge, which is positioned on an opening edge of the cell casing opening when assembled. With such a contact element geometry, the contact element can be positioned in the mounting gap inside the casing during assembly without interference contours or deformation (bend-free).

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1 to 4 show in each case views illustrating a battery cell according to the invention; and

FIGS. 5 to 8 show in each case views illustrating a battery cell according to a comparative example.

### DETAILED DESCRIPTION

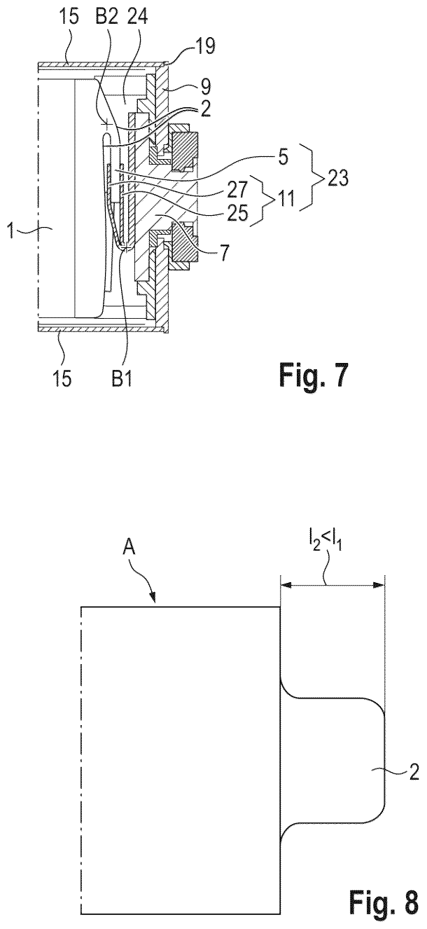

For a simpler understanding of the invention, reference is first made to FIGS. 4 to 8, which show a comparative example. FIG. 7 shows a partial sectional view of a prismatic battery cell in its assembled state. The battery cell has a cell stack 1 inside the cell casing, i.e., an electrode/separator stack, in which anodes and cathodes are arranged alternately on top of each other in a stacking direction S, with separator sheets in between. FIG. 8 shows an example of an anode A. This is formed from a flexible substrate film that is coated with active material. The substrate foil is extended laterally outwards with an uncoated arrester lug 2. The cathodes, which are not shown in more detail, are constructed in the same way. In all figures, of the plurality of arrester lugs 2, only the two outer arrester lugs 2 are shown.

FIG. 7 shows a cell stack side from which all anode-side arrester lugs 2 protrude laterally from the cell stack 1. The laterally outer arrester lug ends are compacted into an anode-side arrester lug bundle 5. The arrester lug bundle 5 is not in direct electrical contact with a cell terminal 7, which is formed in the case back 9 of the cell casing. Rather, the arrester lug bundle 5 is extended with a rigid contact element 11, which is connected to the cell terminal 7. In this way, the arrester lugs 2 of the flexible anodes A can be formed with a reduced overall length 12 (FIG. 8), which simplifies the handling of the arrester lugs 2 during battery manufacturing.

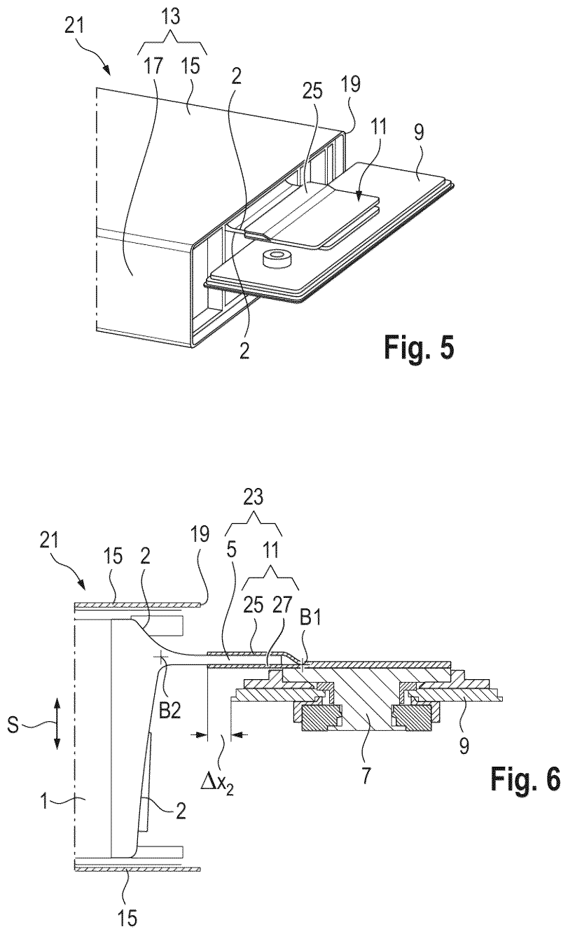

In FIG. 5, 6 or 7, the cell casing has a cuboid casing body 13 in addition to the case back 9. This has two opposing flat side walls 15, which are connected to each other by narrow side walls 17. The walls 15 and 17 delimit opposite cell casing openings 19, of which only one cell casing opening 19 is shown in FIGS. 5 to 7. The cell casing opening 19 is closed in the assembled state by a cover assembly, which includes a casing cover, a cell terminal and an electrically contacted cell stack 1. On the opposite side shown in FIGS. 5, 6 and 7, the inside of the cell casing is closed by the case back 9 in the assembled state (FIG. 7).

FIGS. 5 and 6 show the battery cell as an intermediate battery cell product 21 at a point in the process prior to assembly. As a result, a cover assembly is already inserted into the casing body 13, while the case back 9 is not yet mounted on the casing body 13 to close the casing. Rather, a composite 23 formed of arrester lug bundle 5 and contact element 11 protrudes outwards with a protrusion from the still open cell casing opening 19. The contact element 11 is realized in FIGS. 5 to 7 as a two-layer sheet metal part. Its sheet layers 25, 27 are bent on the side facing the cell stack 1, wherein the arrester lug bundle 5 is positioned between the two sheet layers 25, 27 of the contact element 11. The two sheet layers 25, 27 as well as the intermediate arrester lug bundle 5 are joined together by means of ultrasonic welding.

Based on the process point in time indicated in FIGS. 5 and 6, the case back 9 is positioned in a joining step on the opening edge area of the cell casing opening 19. In the joining step, the composite 23 formed of arrester lug bundle 5 and contact element 11 is folded in a Z-fold around the bending points B1, B2 (FIG. 6 or 7). The first bending point B1 divides the contact element 11 into a contact element section close to the cell stack and a contact element section far from the cell stack. As can be seen from FIG. 6, in the intermediate battery cell product 21, the sheet layers 25, 27 of the contact element 11 protrude beyond the circumferential edge of the case back 9 with an excess of Δx₂. In this way, the length 12 of the arrester lugs 2 can be shortened. However, in order to ensure an assembly free of interference contours, the two contact element sections around the bending point B1 must be folded over each other.

The second bending point B2 is provided in the area of the arrester lugs 2 between the cell stack 1 and the arrester lug bundle 5 (directly at the transition to the arrester lug bundle 5). For the Z-fold, the contact element section far from the cell stack is first bent in a counterclockwise direction around the first bending point B1 opposite to the contact element section close to the cell stack. In addition, the composite 23 formed of arrester lug bundle 5 and contact element 11 is bent clockwise around the second bending point B2, whereby the composite 23 is insertable into a mounting gap 24 inside the casing between the cell stack 1 and the case back 9. Due to their comparatively high inherent stiffness, the contact element sections may not be bent sufficiently around the first bending point B1 during the bending process or may spring back slightly elastically around the first bending point B1. In this case, the problem is that the contact element section close to the cell stack damages or deforms the flexible cell stack side.

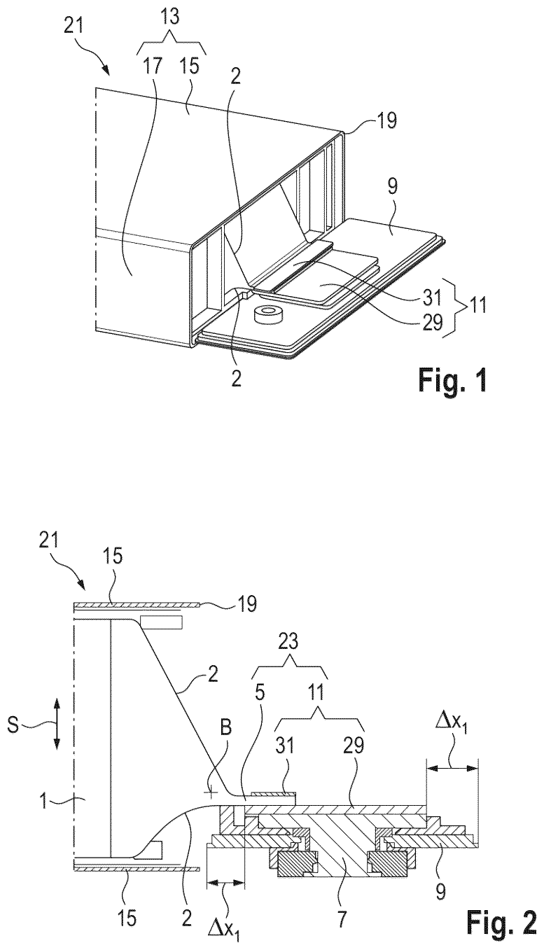

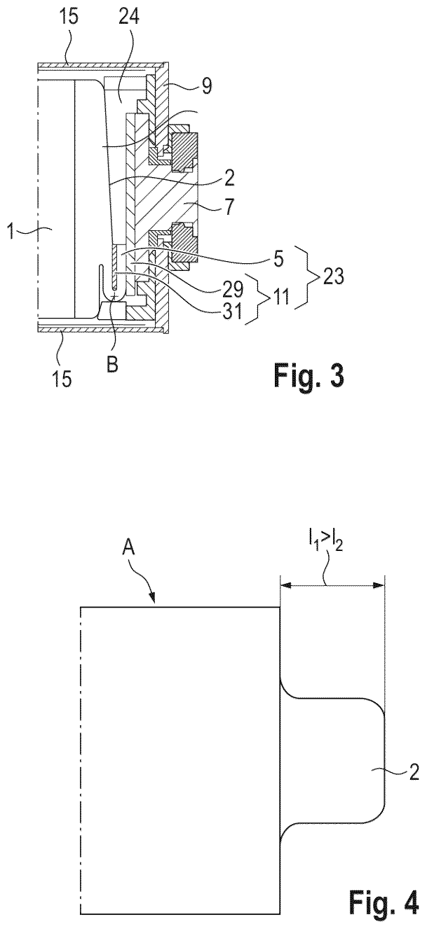

In the following, a measure according to the invention is described on the basis of FIGS. 1 to 4, by means of which such damage or deformation of the flexible cell stack side can be avoided during assembly. The basic structure and functionality of the components shown in FIGS. 1 to 4 is largely identical to the structure and functionality of the components described in FIGS. 4 to 8. For this reason, reference is made to the preliminary description of FIGS. 5 to 8 for FIGS. 1 to 4.

In contrast to the comparative example, according to the invention, the contact element 11 remains undeformed during the bending process, i.e., without bending, while in the bending process only the arrester lugs 2 designed to be flexible are deformed (i.e., bent). In order to avoid bending of the contact element 11, the contact element 11 connected to the cell terminal 7 in the intermediate battery cell product 21 of FIGS. 1 and 2 is—in contrast to the state of the art—dimensioned smaller in diameter than the case back 9. The contact element 11 is therefore set back by one offset Δx₁ (FIG. 2) from the circumferential edge of the case back 9. In this way, the bending point B1 (comparative example, FIG. 6) can be omitted, which is required to fold the cross-sectional contact element 11 for an interference-free assembly.

On the other hand, in the example of FIGS. 1 to 4, the component length 11 of the arrester lugs 2 is only slightly increased as compared to FIG. 8, so that the arrester lugs 2 are not yet more difficult to handle during the manufacturing process.

According to the invention, therefore, only in the area of the arrester lugs 2 between the cell stack 1 and the arrester lug bundle 5 (i.e., at the transition to the arrester lug bundle 5) is exactly one bending axis or bending point B defined, around which the composite 23 formed of arrester lug bundle 5 and contact element 11 can fold into the inner casing mounting gap 24. During assembly, therefore, there is no Z-fold (as in the comparative example), but instead a U-fold, in which the contact element 11 is folded around the bending axis B. The folding is carried out solely by deforming/bending the flexible arrester lugs 5, whereby the composite 23 is positioned in the mounting gap 25, without additional bending of the contact element 11.

As can be seen from FIGS. 1 to 3, the contact element 11 is made in two parts, namely a base sheet part 29 and an additional sheet part 31. The base sheet part 29 is connected to the cell terminal 7. The additional sheet part 31 is joined to the base sheet part 29 by means of ultrasonic welding with the arrester lug bundle 5 in between.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A battery cell comprising:
a cell stack;
a cell casing in which the cell stack is arranged,
wherein an intermediate battery cell product is formed during a process for manufacturing the battery cell, in which the cell stack is arranged inside the casing and an arrester bundle formed from arrester lugs of the cell stack is extended with a contact element that is electrically contactable with a cell terminal of the battery cell,
wherein a composite formed of arrester lug bundle and contact element at substantially right angles to a cell stack stacking direction, protrudes from an open cell casing opening, and
wherein, in an assembled state, the composite formed of arrester lug bundle and contact element is positioned in a bending process in a mounting gap between the cell stack and a wall element or in the cell case back, which closes the cell casing opening, and
wherein, during the bending process, the contact element, which is rigidly formed, remains undeformed so as to be not bent, and only the arrester lugs, which are designed to be flexible are deformed during the bending process.

2. The battery cell according to claim 1, wherein the contact element is connected to the cell terminal, which is part of the wall element.

3. The battery cell according to claim 1, wherein the contact element is constructed in two parts from a base sheet part and a separate additional sheet part, and wherein the base sheet part is connected to the cell terminal.

4. The battery cell according to claim 3, wherein the base sheet part together with the additional sheet part form a weld point or an ultrasonic weld point, in which the arrester lug bundle is welded between the additional sheet part and the base sheet part.

5. The battery cell according to claim 1, wherein the arrester lugs protrude laterally from the cell stack, and/or wherein the laterally outer arrester lug ends are compacted in a pre-fixing step to form the arrester lug bundle in which the arrester lug ends are stacked on top of each other without gaps.

6. The battery cell according to claim 1, wherein, in an area between the cell stack and the arrester lug bundle at a transition to the arrester lug bundle, the arrester lugs define a bending axis or bending point around which the arrester lug bundle is folded into the mounting gap during the bending process.

7. The battery cell according to claim 1, wherein a U-fold is made during the bending process, in which the contact element is folded around the bending axis/bending point, and/or wherein the contact element is positioned in the mounting gap by deforming/bending the flexible arrester lugs.

8. The battery cell according to claim 1, wherein in the intermediate battery cell product, the contact element connected to the cell terminal is smaller in cross-section than the wall element.

9. The battery cell according to claim 8, wherein, in the intermediate battery cell product, the contact element is formed by an offset within a wall element circumferential edge, which lies on an opening edge of the cell casing opening when assembled, so that the contact element is positioned in the mounting gap inside the casing without interference contours and without deformation.

10. A method for manufacturing a battery cell according claim 1, the method comprising:
arranging the cell stack in the cell casing,
forming the intermediate battery cell product during the process of manufacturing the battery cell, in which the cell stack is arranged inside the casing and an arrester bundle formed from arrester lugs of the cell stack is extended with a contact element, which is electrically contacted with a cell terminal of the battery cell, such that a composite formed of arrester lug bundle and contact element at substantially right angles to a cell stack stacking direction protrudes from an open cell casing opening;
positioning, during an assembly, the composite formed of arrester lug bundle and contact element, in a mounting gap between the cell stack and a wall element or the cell case back, which closes the cell casing opening; and
during a bending process, the contact element, which is particularly rigidly formed, remains undeformed so as to be not bent, and such that only the arrester lugs, which are particularly flexible in nature, are deformed during the bending process.
